(19) United States
(12) Patent Application Publication
(10) Pub. No.: US 2021/0144956 A1
(43) Pub. Date: May 20, 2021

(54) ANIMAL DOOR ASSEMBLY AND METHOD OF OPERATION THEREOF

(71) Applicant: Derriss Bohannon, Toledo, OH (US)

(72) Inventor: Derriss Bohannon, Toledo, OH (US)

(21) Appl. No.: 17/095,860

(22) Filed: Nov. 12, 2020

Related U.S. Application Data
(60) Provisional application No. 62/935,317, filed on Nov. 14, 2019.

(51) Int. Cl. A01K 1/04; A01K 27/00; E06B 7/32

(52) U.S. Cl. CPC A01K 1/04; A01K 27/005; E06B 7/32; A01K 27/004; A01K 27/001

(57) ABSTRACT

An animal door assembly and method of operation thereof. The animal door assembly includes an animal door that is connected to, or integrally formed as part of, at least a portion of a door of a user's home, garage, shed, and/or outbuilding. The animal door is selectively movable between a first and second position allowing an animal to enter and exit the user's home, garage, shed, and/or outbuilding. A collar having a collar attachment portion may be selectively attached and detached to and from at least a portion of a leash attachment portion of one or more leashes.

### FIELD OF THE DISCLOSURE

The present disclosure relates to a leash attachment and detachment assembly and a method of operating the leash attachment and detachment assembly. Additionally, the present disclosure relates to a door assembly incorporating at least a portion of the leash attachment and detachment assembly incorporated therein.

### BACKGROUND OF THE DISCLOSURE

Various animal doors and animal leashes are known in the art. Conventional animal doors allow an animal, such as a canine, to enter and leave an user's home. Additionally, conventional animal leashes provides physical a tether that aids in preventing the animal from running away and leaving a pre-determined radius from which another end of the tether is attached. While the conventional animal door allows the animal to freely enter and leave the user's home, it does expose the owner to a number of undesirable vulnerabilities. These vulnerabilities include, but are not limited to, home security by providing thieves with a way to access the interior of the user's home, garage, shed, and/or outbuilding and allows unwanted animals, vermin, bugs, pests, and/or insects to access the interior of the user's home, garage, shed, and/or outbuilding. Additionally, while the conventional animal door allows the animal to freely enter and exit, it does not aid in preventing the animal from running away once the animal has exited the user's home, garage, shed, and/or outbuilding.

It would therefore be advantageous to develop an animal door that provides more security for the owner and aids in preventing unwanted thieves, animals, vermin, bugs, pests, and/or insects from entering into an user's home, garage, shed, and/or outbuilding. Additionally, it would therefore be advantageous to develop an animal door having a leash attachment and detachment assembly that aids in preventing the animal from running away once the animal has exited the user's home, garage, shed, and/or outbuilding.

### SUMMARY OF THE DISCLOSURE

An animal door assembly and method of operation thereof. The animal door assembly includes an animal door that is connected to, or integrally formed as part of, at least a portion of a door of a user's home, garage, shed, and/or outbuilding. The animal door is selectively movable between a first and second position allowing an animal to enter and exit the user's home, garage, shed, and/or outbuilding. A collar having a collar attachment portion may be selectively attached and detached to and from at least a portion of a leash attachment portion of one or more leashes.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a schematic perspective view of an animal door assembly according to an embodiment of the disclosure when an animal is inside and a leash is attached to an animal's collar;

FIG. 2 is a perspective view of the animal door assembly according to the embodiment illustrated in FIG. 1 of the disclosure when the animal is inside and the leash is detached from the animals collar;

FIG. 3 is a schematic perspective view of an animal door assembly according to the embodiment illustrated in FIGS. 1 and 2 of the disclosure when the animal is outside and the leash is attached to the animal's collar;

FIG. 4 is a schematic view of a portion of the animal door assembly illustrated in FIGS. 1-3 of the disclosure when an animal door of the animal door assembly is unlocked;

FIG. 5 is a schematic view of a portion of the animal door assembly illustrated in FIGS. 1-4 of the disclosure when the animal door of the animal door assembly is locked;

FIG. 6 is a schematic perspective view of one or more spool assemblies for use in connection with the animal door assembly illustrated in FIGS. 1-5 of the disclosure;

FIG. 7 is a schematic perspective view of a collar according to an embodiment of the disclosure for use in connection with the animal door assembly illustrated in FIGS. 1-6 of the disclosure;

FIG. 8 is a schematic perspective view of a collar according to an alternative embodiment of the disclosure for use in connection with the animal door assembly illustrated in FIGS. 1-7 of the disclosure;

FIG. 9 is a schematic front view of an animal door assembly according to an alternative embodiment of the disclosure where one or more stop member is in a first position;

FIG. 10 is a schematic front view of the animal door assembly illustrated in FIG. 9 where the one or more stop members are in a second position;

FIG. 11 is a flow chart illustrating a method of operating the animal door assembly illustrated in FIGS. 1-10 according to an embodiment of the disclosure.

### DETAILED DESCRIPTION

It is to be understood that the invention may assume various alternative orientations and step sequences, except where expressly specified to the contrary. It is also to be understood that the specific assemblies and devices illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

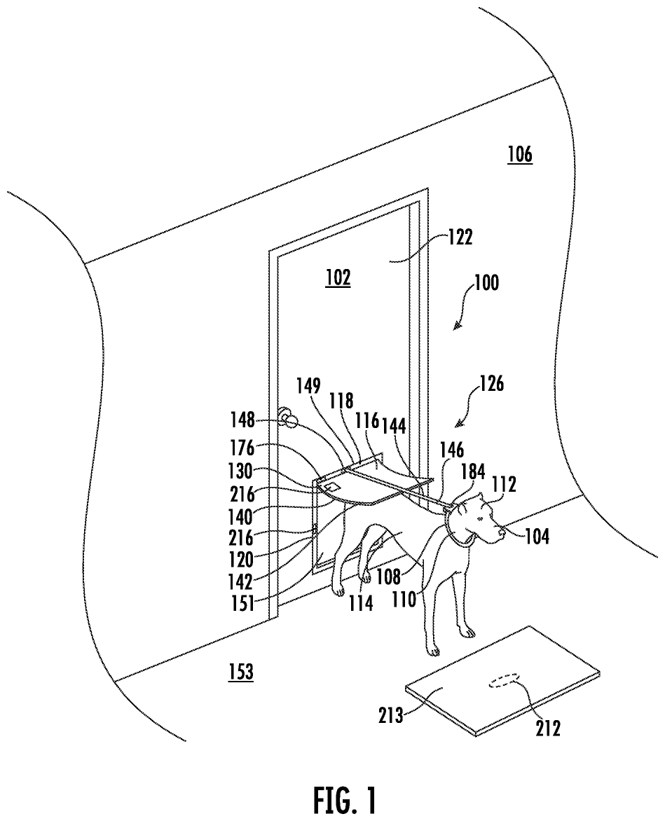

FIGS. 1-7 provide a schematic illustration of an animal door assembly 100 according to an embodiment of the disclosure. As best seen in FIGS. 1-5 of the disclosure and as a non-limiting example, at least a portion of the animal door assembly 100 may be internally connected to, or integrally formed as part of, a door 102. The animal door assembly 100 may be utilized by an animal 104 to enter and/or exit a user's (not shown) home, garage, shed, and/or outbuilding 106. It is within the scope of this disclosure and as a non-limiting example that the door 102 may form at least a portion of, or may be connected to, at least a portion of a user's (not shown) home, garage, shed, or outbuilding 106. Additionally, it is within the scope of this disclosure and as a non-limiting example that the animal 104 may be a pet, a canine, a feline, a dog, a cat, a pig, a goat, and/or any other type of animal that is capable of wearing a collar 108 according to an embodiment of the disclosure.

In accordance with the embodiment illustrated in FIGS. 1-3 of the disclosure and as a non-limiting example, the animal 104 has include a neck portion 110. The neck portion 110 of the animal 104 connects at least a portion of a head 112 of the animal 104 to at least a portion of a body portion, or torso, 114 of the animal 104. It is within the scope of this disclosure and as a non-limiting example that the collar 108 may be of a size and shape to be selectively attached to and detached from at least a portion of the neck portion 110 of the animal 104.

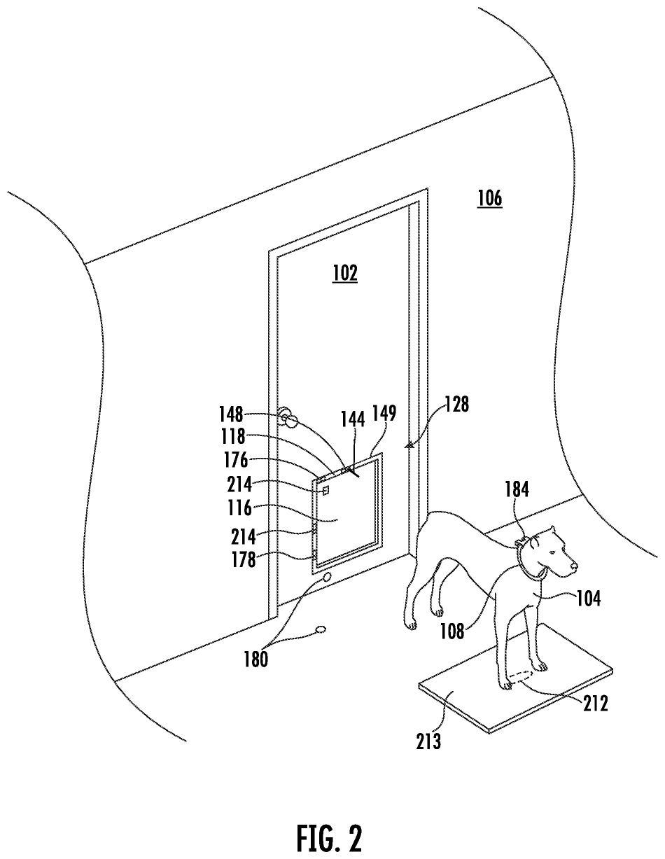

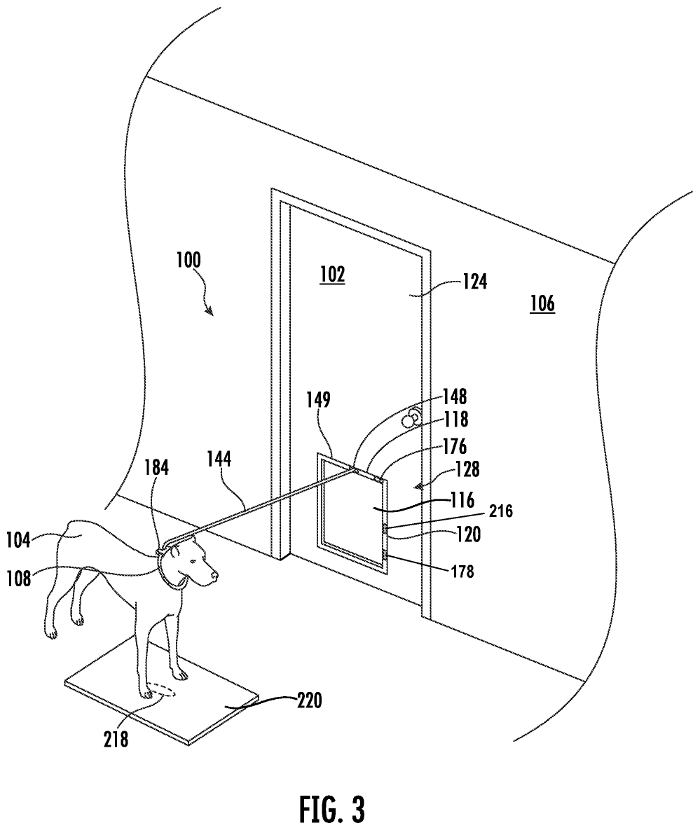

As best seen in FIGS. 1-5 of the disclosure and as a non-limiting example, the animal door assembly 100 may include an animal door 116 and/or an animal door frame 118. The animal door frame 118 may aid in connecting at least a portion of the animal door 116 to at least a portion of the door 102. Additionally, the animal door 116 may be selectively movable between a first position 126 and a second position 128. As illustrated in FIG. 1 of the disclosure and as a non-limiting example, when the animal door 116 is in the first position 126 the animal door 116 may be in an open position allowing the animal 104 to enter and/or exit the user's home, garage, shed, and/or outbuilding 106. As illustrated in FIGS. 2 and 3 of the disclosure and as a non-limiting example, when the animal door 116 is in the second position 128 the animal door 116 may be in a closed position preventing entrance and/or exit into and/or from the user's home, garage, shed, and/or outbuilding 106. When the animal door 116 is in the second position 128, it aids in preventing the animal 104 from exiting the user's home, garage, shed, and/or outbuilding 106 and running away. Additionally, when the animal door 116 is in the second position 128, it aids in preventing thieves, animals, vermin, bugs, pests, and/or insects from entering into an user's home, garage, shed, and/or outbuilding 106.

At least a portion of the animal door 116 and/or the animal door frame 118 may be received and/or retained within at least a portion of an aperture 120 extending from a first side 122 to a second side 124 of the door 102. As a result, it is therefore to be understood that the aperture 120 may be of a size and shape to receive and/or retain at least a portion of the animal door assembly 100 therein. It is within the scope of this disclosure and as a non-limiting example that at least a portion of the animal door 116 and/or the animal door frame 118 may be integrally formed as part of or integrally connected to at least a portion of the door 102. As a non-limiting example, the animal door 116 and/or the animal door frame 118 may be integrally connected to at least a portion of the door 102 by using one or more mechanical fasteners, one or more rivets, one or more snap connectors, and/or one or more welds.

In accordance with the embodiment illustrated in FIG. 1 and as a non-limiting example, at least a portion of a top portion 130 of the animal door 116 may be connected to at least a portion of the animal door frame 118 and/or the door 102. This aids in allowing the animal door 116 to selectively transition between the first position 126 and the second position 128. It is within the scope of this disclosure and as a non-limiting example, at least a portion of the top portion 130 of the animal door 116 may be hinegedly connected to at least a portion of the animal door frame 118 and/or the door 102.

According to an embodiment of the disclosure and as a non-limiting example at least a portion of the animal door 116 may be drivingly connected to at least a portion of a motor (not shown). The motor (not shown) may be operably configured to selectively transition the animal door 116 between the first and second position 126 and 128. In accordance with this embodiment of the disclosure and as a non-limiting example, the animal door 116 may have a plurality of teeth (not shown) thereon that are complementary to and meshingly engaged with a gear or gear assembly (not shown) drivingly connected to at least a portion of the motor (not shown). This aids in ensuring that the animal door 116 is only opened once a pre-determined condition has been met thereby aiding in preventing thieves, animals, vermin, bugs, pests, and/or insects from entering into an user's home, garage, shed, and/or outbuilding 106. It is within the scope of this disclosure and as a non-limiting example that when the animal door 116 is in the first position 126, or the open position, at least a portion of the animal door 116 may be received and/or retained within at least a portion of a hollow interior portion (not shown) of the door 102. As a non-limiting example, the motor (not shown) may be an electric motor.

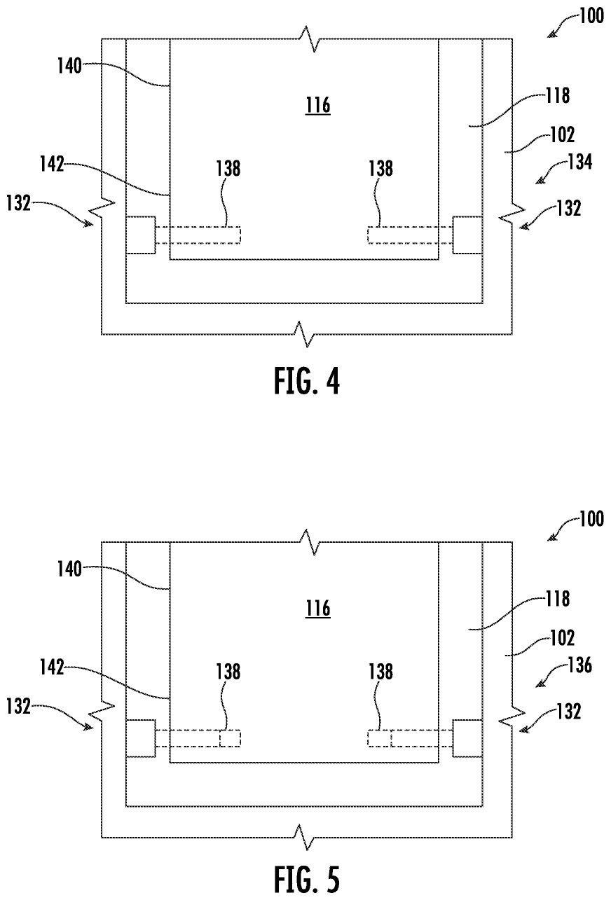

As best seen in FIGS. 4 and 5 of the disclosure and as a non-limiting example, the animal door assembly 100 may include one or more locking assemblies 132. The one or more locking assemblies 132 may be operably configured to selectively transition between a first position 134 and a second position 136. When the one or more locking assemblies 132 are in the first position 134 illustrated in FIG. 4 and as a non-limiting example, the one or more locking assemblies 132 are not in contact with or engagable with the animal door 116 of the animal door assembly 100 thereby allowing the animal door 116 to open. When the one or more locking assemblies 132 are in the second position illustrated in FIG. 5 and as a non-limiting example, at least a portion of the one or more locking assemblies 132 may be engaged with at least a portion of the animal door 116 thereby preventing it from opening. This aids in preventing thieves, animals, vermin, bugs, pests, and/or insects from entering into an user's home, garage, shed, and/or outbuilding 106. It is within the scope of this disclosure and as a non-limiting example that the first position 134 of the one or more locking assemblies 132 may be an unlocked position and the second position 136 of the one or more locking assemblies 132 may be a locked position. As a non-limiting example, the one or more locking assemblies 132 may be one or more linear actuators and/or any other mechanism that will aid in preventing the animal door 116 from opening.

In accordance with the embodiment illustrated in FIG. 5 and as a non-limiting example, when the one or more locking assemblies 132 are in the second position 136, at least a portion of the one or more locking assemblies 132 may be received and/or retained within one or more lock receiving portions 138 within the animal door 116. According to an embodiment of the disclosure and as a non-limiting example, the one or more lock receiving portions 138 may be disposed within at least a portion of an intermediate portion 140 and/or bottom portion 142 of the animal door 116. Once at least a portion of the one or more locking assemblies 132 are received and/or retained within the one or more lock receiving portions 138 within the animal door 116, the animal door 116 is locked and prevented from being opened. This aids in preventing thieves, animals, vermin, bugs, pests, and/or insects from entering into an user's home, garage, shed, and/or outbuilding 106.

The pet door assembly 100 may include one or more leashes 144. As best seen in FIGS. 1-3 of the disclosure and as a non-limiting example, at least a portion of a first end portion 146 of the one or more leashes 144 may be selectively connected to at least a portion of the collar 108. Additionally, as illustrated in FIGS. 1-3 of the disclosure and as a non-limiting example, at least a portion of an end of the one or more leashes 144 opposite the animal 104 may be connected to at least a portion of the animal door assembly 100 and/or the door 102. As a result, the one or more leashes 144 aid in tethering the animal 104 and providing a physical restraint that prevents the animal 104 from moving beyond a pre-determined radius from the animal door assembly 100 and/or the door 102. This aids in preventing the animal 104 from running away after the animal 104 has utilized the animal door assembly 100 to exit the user's home, garage, shed, or outbuilding 106. It is within the scope of this disclosure and as a non-limiting example, the length of the one or more leashes 144 and therefore the pre-determined radius the animal may move away from the animal door assembly 100 and/or the door 102 may be set and selectively changed by the user (not shown).

According to an embodiment of the disclosure and as a non-limiting example, the end of the one or more leashes 144 opposite the animal 104 may be connected to at least a portion of one or more spool assemblies 148. At least a portion of the one or more spool assemblies 148 may be integrally connected to and/or housed within at least a portion of the animal door frame 118 of the animal door assembly 100 and/or the door 102. The one or more spool assemblies 148 may be operably configured to unspool a pre-determined amount of the one or more leashes 144 substantially equal to the pre-determined radius set by the user (not shown). Additionally, the one or more spool assemblies 148 may be operably configured to roll up at least a portion of the one or more leashes 144 thereby providing the animal door assembly 100 with one or more leashes 144 that are retractable. It is therefore within the scope of this disclosure and as a non-limiting example that at least a portion of the one or more leashes 144 may be stored within at least a portion of the animal door frame 118 of the animal door assembly 100 and/or the hollow interior portion (not shown) of the door 102.

According to the embodiment illustrated in FIGS. 1-3 of the disclosure and as a non-limiting example, at least a portion of the one or more spool assemblies 148 may be disposed within at least a portion of a top portion 149 of the animal door frame 118 of the animal door assembly 100. This aids in ensuring that the first end portion 146 of the one or more leashes 144 hangs within an opening 151 at a height substantially equal to the distance between the collar 108 and the ground 153 on which the animal 104 is standing at the attachment stage. The opening 151 may be of a size and shape needed to allow the animal 104 to pass therethrough as needed during operation of the animal door assembly 100. It is within the scope of this disclosure and as a non-limiting example that the height (not shown) may be set and recorded by the user (not shown) within the animal door assembly 100. This aids in ensuring that the animal door assembly 100 functions and operates in the same manner each time that it is used by the animal 104 which provides a more reliable animal door assembly 100. As a non-limiting example, the height (not shown) may be set by the user (not shown) manually or electronically within one or more control units 162 of the animal door assembly 100.

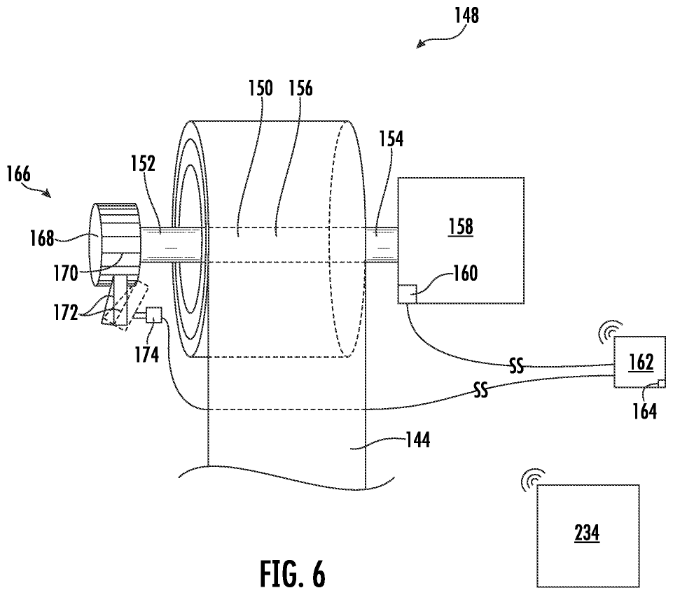

As best seen in FIG. 6 of the disclosure and as a non-limiting example, the one or more spool assemblies 148 may include one or more rod members 150 having a first end portion 152, a second end portion 154, and in intermediate portion 156 interposed between the first and second end portions 152 and 154. The one or more rod members 150 may provide an axis of rotation for the one or more leashes 144 within the one or more spool assemblies 148. Additionally, the one or more rod members 150 may apply an amount of force onto the one or more leashes 144 needed to wind up and retract at least a portion of the one or more leashes 144 into the animal door frame 118 of the animal door assembly 100 and/or the door 102 for storing therein. It is with the scope of this disclosure and as a non-limiting example that at least a portion of the one or more leashes 144 may be wrapped or spooled around at least a portion of the intermediate portion 156 of the one or more rod members 150.

In accordance with the embodiment of the disclosure illustrated in FIG. 6 and as a non-limiting example, the one or more spool assemblies 148 may include one or more rotation devices 158. The one or more rotation devices 158 may be integrally connected to at least a portion of the second end portion 154 of the one or more rod members 150 of the one or more spool assemblies 148. The one or more rotational devices 158 may be operably configured to rotate the one or more rod members 150 clockwise and/or counter-clockwise as needed to feed out and/or retract the one or more leashes 144. It is within the scope of this disclosure and as a non-limiting example that the one or more rotation devices 158 may be one or more biasing members, one or more motors, and/or one or more electric motors.

In accordance with the embodiment where the one or more rotation devices 158 are one or more electric motors, the one or more rotational devices 158 may include one or more sensors 160 therein that are in communication with at least a portion of the one or more control units 162 of the animal door assembly 100. The one or more sensors 160 may be operably configured to sense the rotation of the one or more rod members 150. The data collected by the one or more sensors 160 may be analyzed by one or more data processors 164 in communication with the one or more control units 162 in order to determine how much of the one or more leashes 144 has feed out. The amount which the one or more leashes 144 have been fed out determines the radius that the animal 104 is able travel away from the animal door frame 118 of the animal door assembly 100 and/or the door 102. Once the user (not shown) has set or recorded a pre-determined radius within with animal door assembly 100, the one or more control units 162 may be operably configured to cut power to the one or more rotational devices 158 in order to prevent the one or more leashes 144 from being fed out from the one or more spool assemblies 148 beyond the pre-determined radius set by the user. It is within the scope of this disclosure and as a non-limiting example that at least a portion of the one or more control units 162 may be received and/or retained within at least a portion of the animal door frame 118 of the animal door assembly 100 and/or the door 102.

According to the embodiment illustrated in FIG. 6 of the disclosure and as a non-limiting example, the one or more spool assemblies 148 may include one or more ratchet assemblies 166. At least a portion of the one or more ratchet assemblies 166 may be connected to at least a portion of the first end portion 152 f the one or more rod members 150 of the one or more spool assemblies 148. The one or more ratchet assemblies 166 may include one or more gear wheels 168 having a plurality of teeth 170 thereon. The plurality of teeth 170 of the one or more gear wheels 168 may be selectively engagable with at least a portion of one or more pawls 172. When the one or more pawls 172 are engaged with the plurality of teeth 170 of the one or more gear wheels 168, the one or more rod members 150 are prevented from rotating. Additionally, when the one or more pawls 172 are not engaged with the plurality of teeth 170, the one or more rod members 150 may be able to freely rotate clockwise and counter-clockwise. As a result, once the one or more leashes 144 of been fed out a length substantially equal to the pre-determined radius set by the user (not shown), the one or more pawls 172 may engage the plurality of teeth 170 of the one or more gear wheels 168 to as to prevent the one or more rod members 150 and the one or more leashes 144 from rotating.

At least a portion of the one or more pawls 172 may be drivingly connected to at least a portion of one or more pawl motors 174. The one or more pawl motors 174 may be operably configured to selectively drive the one or more pawls 172 into and out of engagement with the plurality of teeth 170 of the one or more gear wheels 168. Once the one or more control units 162 have determined that the one or more leashes 144 have been fed out a length substantially equal to the pre-determined radius set by the user (not shown), the one or more control units 162 may instruct the one or more pawl motors 174 to drive the one or more pawls 172 into engagement with the plurality of teeth 170 of the one or more gear wheels 168. As a non-limiting example, the one or more pawl motors 172 may be one or more electric motors, one or more linear actuators, and/or any other device capable of transitioning the one or more pawls 172 into and out of engagement with the plurality of teeth 170 of the one or more gear wheels 168.

It is within the scope of this disclosure and as a non-limiting example that at least a portion of the one or more rod members 150 may be rotationally connected to at least a portion of the animal door frame 118 and/or the door 102.

The animal door assembly 100 may include one or more speakers 176 in communication with at least a portion of the one or more control units 162 of the animal door assembly. At least a portion of the one or more speakers 176 may be housed within and integrally connected to at least a portion of the animal door frame 118 of the animal door assembly 100 and/or the door 102. The one or more speakers 176 may be operably configured to emit one or more sounds that are at least audible by the animal 104. It is within the scope of this disclosure and as a non-limiting example that the one or more speakers 176 may emit one or more audio files stored within the one or more control units 162. As a non-limiting example, the one or more audio files may be one or more commands issued by the user, one or more instructions for the animal 104, one or more words of encouragement for the animal 104, one or more calls to bring the animal 104 to the animal door assembly 100, and/or anything else that may be useful in heling the animal 104 use the animal door assembly 100.

As best seen in FIG. 2 of the disclosure and as a non-limiting example, the animal door assembly 100 may include one or more treat dispensers 178. The one or more treat dispensers 178 may be operably configured to dispense one or more treats 180 that are consumable by the animal 104 when the animal 104 has successfully used the animal door assembly 100. By dispensing one or more treats 180 from animal door assembly 100, it aids in helping train the animal 104 how to use the animal door assembly 104. It is within the scope of this disclosure and as a non-limiting example that the amount of treats 180 dispensed by the animal door assembly 100 may be set to a pre-determined amount by the user (not shown).

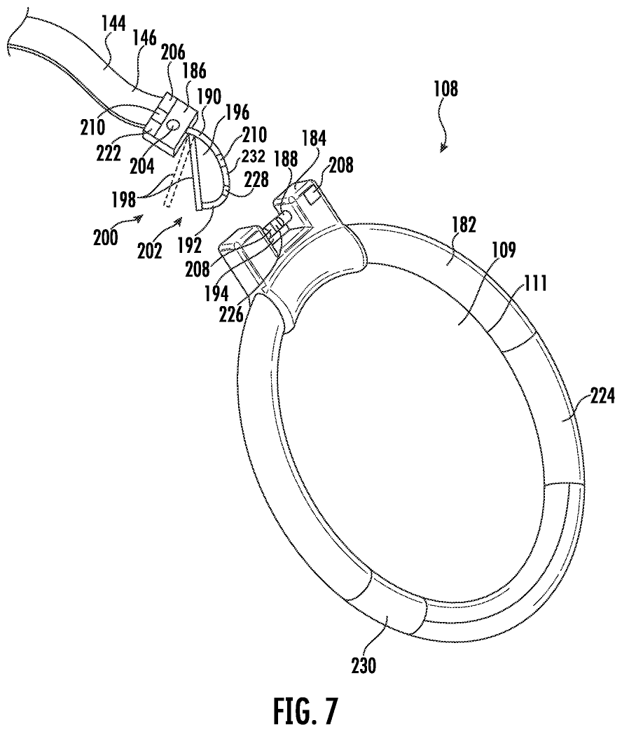

In accordance with the embodiment illustrated in FIG. 7 of the disclosure and as a non-limiting example, the collar 108 may include a body portion 182 having a size and shape to securely attach to at least a portion of the neck portion 110 of the animal 104. Integrally connected to, or integrally formed as part of, at least a portion of the body portion 182 of the collar 108 is a collar attachment portion 184. The collar attachment portion 184 may be selectively attached and/or detached to and/or from at least a portion of a leash attachment portion 186. As best seen in FIG. 7 and as a non-limiting example, at least a portion of the leash attachment portion 186 of the one or more leashes 144 may be integrally connected to, or integrally formed as part of, at least a portion the first end portion 146 of the one or more leashes 144.

The body portion 182 of the collar 108 may have an opening 109 therein defined by a surface 111. The opening 109 and/or the surface 111 of the collar 108 may have a size and shape that is substantially complementary to the shape of at least a portion of the neck portion 110 of the animal 104. As a result, it is therefore to be understood that the collar 108 may be form fitting to the animal 104 using the animal door assembly 100. This aids in preventing the collar 108 from rotating and/or moving around and/or along the neck portion 110 of the animal 104. By providing a collar 108 that does not rotate and/or move around and/or along the neck portion 110 of the animal 104, it aids in ensuring that the collar attachment portion 184 of the collar 108 remains within the approximately in the same location at all times while on the neck portion 110 of the animal 104. This aids in providing an animal door assembly 100 that is capable of consistently and reliably attaching at least a portion of the collar attachment portion 184 of the collar 108 to at least a portion of the leash attachment portion 188 of the one or more leashes 144.

According to the embodiment illustrated in FIG. 7 and as a non-limiting example, the collar attachment portion 184 of the collar 108 may include an attachment rod 188 that is selectively engagable with a at least a portion of a hook member 190 of the leash attachment portion 186 of the one or more leashes 144. At least a portion of a first end portion 192 of the hook member 190 of the leash attachment portion 186 may be received and/or retained within an opening 194 between the attachment rod 188 and the body portion 182 of the collar 108. Once at least a portion of the hook member 190 of the leash attachment portion 186 of the one or more leashes 144 have been received within at least a portion of the opening 194, at least a portion of the attachment rod 188 of the collar 108 may be received and/or retained within at least a portion of an opening 196 within the leash attachment portion 186 of the one or more leashes 144. As best seen in FIG. 7 and as a non-limiting example, the opening 196 within the leash attachment portion 186 of the one or more leashes 144 may be defined by at least a portion of the hook member 190 and/or a locking member 198 of the leash attachment portion 186 of the one or more leashes 144.

Once at least a portion of the attachment rod 188 of the collar 108 is received within at least a portion of the opening 196 within the leash attachment portion 186 of the one or more leashes 144, the locking member 198 of the leash attachment portion 186 may transition from a first position 200 to a second position 202. As a result, it is therefore to be understood that the locking member 198 of the leash attachment portion 186 may be selectively transitionable between the first and second position 200 and 202. It is within the scope of this disclosure and as a non-limiting example that when the locking member 198 is in the first position 200 illustrated in FIG. 7, the leash attachment portion 186 of the one or more leashes 144 may be in an unlocked position. Additionally, it is within the scope if this disclosure and as a non-limiting example that when the locking member 198 is in the second position 202 illustrated in FIG. 7, the leash attachment portion 186 of the one or more leashes 144 may be in a locked position. As a non-limiting example, the locking member 198 may be selectively transitioned between the first and second positions 200 and 202 manually by the user (not shown) and/or automatically by using one or more mechanical mechanisms drivingly connected to at least a portion of the locking member 198.

In accordance with the embodiment where the locking member 198 is selectively transitionable between the first and second position 200 and 202 manually, the user (not shown) may physically move the locking member 198 into the desired position. This provides the animal door assembly 100 with a fail-safe mechanism thereby providing an animal door assembly 100 that is more reliable.

It is within the scope of this disclosure and as a non-limiting example that the user (not shown) may selectively manually transition the locking member 198 between the first and second positions 200 and 202 by interacting with a locking member movement mechanism 204. The locking member movement mechanism 204 may be a mechanical mechanism that when utilized by the user (not shown) allows the locking member 198 to be transitioned between the first and second positions 200 and 202. As a non-limiting example, at least a portion of the locking member movement mechanism 204 may be located within at least a portion of the leash attachment portion 186 of the one or more leashes 144.

According to the embodiment where the locking member 198 of the leash attachment portion 186 of the one or more leashes 144 is automatically transitioned between the first and second positions 200 and 202, the leash attachment portion 186 of the one or more leashes 144 may include one or more motors 206 that are drivingly connected to at least a portion of the locking member 198. The one or more motors 206 of the leash attachment portion 186 of the one or more leashes 144 may be in communication with the one or more control units 162 of the animal door assembly 100. Upon the occurrence of one or more pre-determined conditions, the one or more control units 162 may instruct the one or more motors 206 of the locking member 198 to transition between the first and second positions 200 and 202. It is within the scope of the disclosure and as a non-limiting example that the one or more motors 206 of the leash attachment portion 186 may be one or more motors, one or more electric motors, one or more linear actuators, and/or any other mechanism that is capable or transitioning the locking member 198 between the first and second positions 200 and 202.

Once the one or more control units 162 have determined that the collar attachment portion 184 of the collar 108 and the leash attachment portion 186 of the one or more leashes 144 have been positioned relative to each other such that at least a portion of the attachment rod 188 may be locked within the opening 196 of the leash attachment portion 186, the one or more control units 162 may instruct the one or more motors 206 to transition the locking member 198 from the first position 200 to the second position 202. This may be determined using one or more collar sensors 208 and/or one or more leash sensors 210. It is within the scope of this disclosure and as a non-limiting example that the one or more collar sensors 208 may be disposed within or integrally connected to at least a portion of the collar attachment portion 184 and/or the attachment rod 188 of the collar attachment portion 184. Additionally, it is within the scope of this disclosure and as a non-limiting example that the one or more leash sensors 210 may be disposed within or integrally connected to at least a portion of the leash attachment portion 186 and/or the hook member 190 of the leash attachment portion 186. After the one or more control units 162 have determined that the attachment rod 188 and the hook member 190 are disposed a pre-determined distance from each other indicating that at least a portion of the attachment rod 188 may be locked within the opening 196 of the leash attachment portion 186, the one or more control units 162 may instruct the locking member 198 to transition from the first position 200 to the second position 202. It is within the scope of this disclosure and as a non-limiting example that the one or more collar sensors 208 and the one or more leash sensors 210 may be one or more proximity sensors, one or more RFID sensors, one or more magnetic sensors, one or more infrared sensors, one or more sonar sensors, one or more cameras, and/or any other type of sensor capable of determining and/or sensing the distance between the hook member 190 and the attachment rod 188.

Once the one or more control units 162 have determined that the animal 104 is ready to be detached from the one or more leashes 144, the one or more control units 162 may instruct the locking member 198 of the leash attachment portion 186 to transition from the second position 202 to the first position 200. This may be determined by using one or more first mat sensors 212, one or more second mat sensors 218, the one or more collar sensors 208, the one or more leash sensors 210, and/or one or more first animal door sensors 214 that are in communication with the one or more control units 162 to confirm that the animal 104 is within the user's home, garage, shed, or outbuilding 106. At least a portion of the one or more first mat sensors 212 may be integrally formed as part of, or integrally connected to, at least a portion of a first mat 213 located within the user's home, garage, shed, or outbuilding 106. Additionally, at least a portion the one or more second mat sensors 218 may be integrally formed as part of, or integrally connected to, at least a portion of a second mat 220 located outside the user's home, garage, shed, or outbuilding 106. Furthermore, at least a portion of the one or more first animal door sensors 214 may be integrally formed as part of, or integrally connected to, at least a portion of the animal door 116 and/or the animal door frame 118 located within the user's home, garage, shed, or outbuilding 106. As a non-limiting example the one or more first and/or second mat sensors 212 and/or 218 may be one or more pressure sensors, one or more proximity sensors, one or more RFID sensors, one or more magnetic sensors, one or more infrared sensors, one or more sonar sensors, one or more cameras, and/or any other type of sensor capable of determining and/or sensing the location of the animal 104, the collar 108, and/or the leash attachment portion 186 of the one or more leashes 144. Additionally, as a non-limiting example, the one or more first animal door sensors 214 may be one or more proximity sensors, one or more RFID sensors, one or more magnetic sensors, one or more infrared sensors, one or more sonar sensors, one or more cameras, and/or any other type of sensor capable of determining and/or sensing the location of the animal 104, the collar 108, and/or the leash attachment portion 186 of the one or more leashes 144.

In accordance with the embodiment where the one or more first and/or second mat sensors 212 and 218 are one or more pressure sensors, the user may set and record within the one or more control units 162 of the animal door assembly 100 a pre-determined weight needed to indicate to the one or more control units 162 that the animal 104 is within the user's home, garage, shed, or outbuilding 106. This aids in providing an animal door assembly 100 that is customizable to the animal 104 using the animal door assembly 100. Once the animal 104 steps on the one or more first and/or second mat sensors 212 and/or 218 within the first and/or second mat 213 and/or 220 and the one or more control units 162 confirm that the weight condition set by the user is met, the one or more control units 162 may instruct the leash attachment portion 186 to detach from the collar attachment portion 184. This may include the step of the one or more control units 162 instructing the locking member 198 of the leash attachment portion 186 to transition from the second locked position 202 to the first unlocked position 200.

It is within the scope of this disclosure and as a non-limiting example that the animal door assembly 100 may include one or more second animal door sensors 216 in communication with the one or more control units 162. The one or more second animal door sensors 216 may be operably configured to aid in determining or confirming that the one or more leashes 144 have been successfully connected to at least a portion of the collar 108 on the animal 104. At least a portion of the one or more second animal door sensors 216 may be integrally formed as part of, or integrally connected to, at least a portion of the animal door frame 118 and/or the animal door 116 located outside the user's home, garage, shed, or outbuilding 106. In the event that the one or more control units 162 have determined that the animal door assembly 100 failed to connect the one or more leashes 144 to the collar 108 on the animal 104, the one or more control units 162 may instruct the animal door assembly 100 to bring the animal 104 back to keep the animal 104 from running away. It is within the scope of this disclosure and as a non-limiting example that the one or more control units 162 may instruct the one or more speakers 176 to audibly issue a command to bring the animal 104 back into the user's home, garage, shed, or outbuilding 106 and/or may instruct the animal door assembly 100 to dispense one or more treats 180. As a non-limiting example, the one or more treats 180 may be dispensed inside and/or outside the user's home, garage, shed, or outbuilding 106. Additionally, as a non-limiting example, the one or more second animal door sensors 216 may be one or more proximity sensors, one or more RFID sensors, one or more magnetic sensors, one or more infrared sensors, one or more sonar sensors, one or more cameras, and/or any other type of sensor capable of determining and/or sensing the location of the animal 104 and/or the collar 108.

After the one or more control units 100 of the animal door assembly 100 have determined that the animal 100 is safely back within the user's home, garage, shed, or outbuilding 106, the animal door 116 may be closed and/or locked. The one or more control units 162 may determine this by using the one or more first mat sensors 212, the one or more first mat sensors 218, the one or more collar sensors 208, the one or more leash sensors 210, and/or the one or more first animal door sensors 214. This aids in providing an animal door assembly 100 having one or more failure detection mechanisms that aid in preventing the animal 104 from running away and/or exiting the user's home, garage, shed, or outbuilding 106 without being securely connected to at least a portion of the one or more leashes 144.

According to an embodiment of the disclosure and as a non-limiting example, at least a portion of the hook member 190 of the leash attachment portion 186 and/or the attachment rod 188 of the collar attachment portion 184 may be made of a magnetic material, an electro-magnetic material, and/or a material that is magnetizable. By providing a magnetic attraction between the hook member 190 and the attachment rod 188, it aids in ensuring that at least a portion of the attachment rod 188 is consistently and reliably received and/or retained within at least a portion of the opening 196 within the leash attachment portion 186 of the one or more leashes 144. This is achieved by providing a magnetic attraction between the collar attachment portion 184 and the leash attachment portion 186.

In accordance with the embodiment where at least a portion of the hook member 190 and/or the attachment rod 188 are made of an electro-magnetic material and/or a material that is magnetizable, the leash attachment portion 186 may include one or more leash power sources 222 and the collar 108 may include one or more collar power sources 224. The one or more one or more leash power sources 222 and the one or more collar power sources 224 may be in electrical communication with at least a portion of the hook member 190 and/or the attachment rod 188. Additionally, the one or more leash power sources 222 and the one or more collar power sources 224 may be in communication with the one or more control units 162. When the one or more control units 162 determine that the leash attachment portion 186 is to be attached to the collar attachment portion 184, the one or more control units 162 may instruct the one or more leash power sources 222 and the one or more collar power sources 224 to supply an amount of power needed to create the magnetic attraction needed to draw the hook member 190 and/or the attachment rod 188 toward each other. In order to conserve power and improve the overall life of the one or more leash power sources 222 and the one or more collar power sources 224, once the one or more control units 162 have determined that the leash attachment portion 186 has been successfully attached to at least portion of the collar attachment portion 184, the one or more control units 162 may instruct the one or more leash power sources 222 and the one or more collar power sources 224 to stop supplying an amount of power to the hook member 190 and/or the attachment rod 188. It is within the scope of this disclosure and as a non-limiting example that the one or more leash power sources 222 and the one or more collar power sources 224 may be one or more batteries, one or more electro-chemical cells, one or more secondary cells, one or more rechargeable batteries, and/or any other type of device capable of supplying an amount of electrical power.

The one or more leash power sources 222 may be in electrical communication with so as to provide the power needed to operate the one or more motors 206 and/or the one or more leash sensors 210 of the one or more leashes 144. Additionally, the one or more collar power sources 224 may be in electrical communication with so as to provide the power needed to operate the one or more collar sensors 208 and/or a GPS unit 230 of the collar 108.

As best seen in FIG. 7 of the disclosure and as a non-limiting example, the hook member 190 of the leash attachment portion 186 may include a hook magnetic member 228 and the attachment rod 188 may include an attachment rod magnetic member 226. The attachment rod magnetic member 226 and the hook magnetic member 228 may be magnetically attracted to each other. It is within the scope of this disclosure and as a non-limiting example that the hook magnetic member 228 may be attached to an intermediate portion 232 of the hook member 190. This aids in ensuring that at least a portion of the first end portion 192 of the hook member 190 passes through the opening 194 within the collar attachment portion 184 thereby allowing the locking member 198 to transition from the first unlocked position 200 to the second locked position 202 and securing at least a portion of the attachment rod 188 within the opening 196 of the leash attachment portion 186. As a result, it is therefore to be understood that the hook magnetic member 228 and the attachment rod magnetic member 226 aid in ensuring that the leash attachment portion 186 is reliably connected to at least a portion of the collar attachment portion 184.

According to an embodiment of the disclosure and as a non-limiting example, the collar 108 may include the GPS unit 230 that is in electrical communication with at least a portion of the one or more collar power sources 224. The GPS unit 230 may be utilized by the animal door assembly 100 to provide the user (not shown) with real time coordinates, or the real time location, of the animal 104. This aids in helping ensuring that the animal 104 is not lost and aids in providing the user (not shown) with the assurances and peace of mind desired confirming that the animal door assembly 100 is functioning properly and that the animal 104 has not run away. The GPS unit 230 may be in communication with the one or more control units 162. It is within the scope of this disclosure and as a non-limiting example that the real time coordinates, or the real time location, of the animal 104 may be transmitted to the one or more control units 162. Once received by the one or more control units 162, the real time coordinates, or the real time location, of the animal 104 may be retrieved by the user (not shown) as needed by communicating the information from the one or more control units 162 one or more computing devices 234.

By utilizing the GPS unit 230, the one or more control units 162 may be operably configured to determine if the animal 104 has gotten loose or ran away. This may be determined by determining that the animal 104 has moved beyond a geographic perimeter or boundary set by the user (not shown). Once it has been determined that the animal 104 has moved beyond the geographic perimeter or boundary set, the one or more control units 162 may send an alert to the user (not shown) through the one or more computing devices 234.

The one or more control units 162 may be in communication with the one or more computing devices 234. The one or more control units 162 of the animal door assembly 100 may be in wired or wireless communication with the one or more computing devices 234. The one or more computing devices 234 may interact with the one or more control units 162 of the animal door assembly 100 by utilizing a program or application (not shown) that is downloadable onto the one or more computing devices 234. The downloadable program or application (not shown) may include a user interface that allows the user (not shown) to enter an amount of information therein needed to operate, or customize the operation of, the animal door assembly 100. It is within the scope of this disclosure and as a non-limiting example that the one or more computing devices 234 may be one or more phones, one or more tablet devices, one or more computers, and/or any other type of computing device that is capable of communicating with the one or more computing devices 162. As a non-limiting example, the one or more computing devices 234 may be in wireless communication with the one or more control units 162 by utilizing a cellular connection, a wireless connection, an internet connection, and/or any other type of wired or wireless method for transmitting information from one device to another.

According to an embodiment of the disclosure and as a non-limiting example, the user (not shown) may enter one or more of the following into the downloadable program or application (not shown) on the one or more computing devices 234 needed for operation of the animal door assembly 100: the pre-determined radius or length to be fed out by the animal door assembly 100, the pre-determined weight of the animal 104, an animal door 116 lock command, an animal door 116 unlock command, a command to dispense the one or more treats 180, a command setting the number of the one or more treats 180 that will be dispensed at a given time, what alerts are sent to the user (not shown), an animal 104 loose alert, a failure to attach alert, a height or distance from which the leash attachment portion 186 hangs from the ground or floor 153, an animal exit alert, an animal re-entry alert, and/or any other type of information needed to operate the animal door assembly 100.

It is within the scope of this disclosure and as a non-limiting example that the animal door assembly 100 may be programed to only allow a particular pre-determined collar 108 to operate the animal door assembly 100. This aids in ensuring that only the user's animal 104 is able to operate their animal door assembly 100 and provides an additional level of security by preventing unwanted animals from entering the user's home, garage, shed, and/or outbuilding 106. This unique identifier may be set by the user (not shown) within the downloadable program or application (not shown) on the one or more computing devices 234, by pairing the collar 108 with the downloadable program or application (not shown) on the one or more computing devices 234, and/or by pairing the collar 108 with the one or more control units 162 of the animal door assembly 100.

While the leash attachment portion 186 has been illustrated to include the hook member 190 and the collar attachment portion 184 has been illustrated to include the attachment rod 188, it is within the scope of this disclosure and as a non-limiting example that the collar 108 may include the attachment portion 186 described and illustrated herein and the one or more leashes 144 may include the attachment portion 184 described and illustrated herein.

In light of the foregoing, the animal door assembly 100 provides more security for the user (not shown) and aids in preventing unwanted thieves, animals, vermin, bugs, pests, and/or insects from entering into a user's home, garage, shed, and/or outbuilding 106. Additionally, in light of the foregoing, the animal door assembly 100 prevents the animal 104 from running away once the animal 104 has exited the user's home, garage, shed, and/or outbuilding 106.

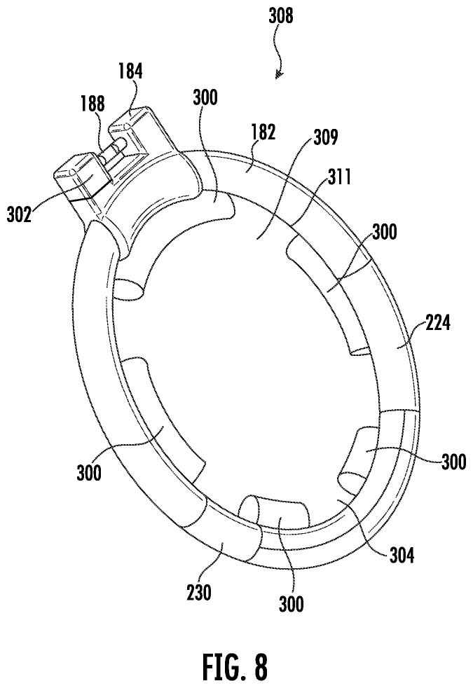

FIG. 8 provides a schematic perspective view of a collar 308 according to an alternative embodiment of the disclosure. The collar 308 illustrated in FIG. 8 is the same as the collar 108 illustrated in FIGS. 1-7, except where specifically noted below. As best seen in FIG. 8 of the disclosure and as a non-limiting example, the body portion 182 of the collar 308 may include an opening 309 therein defined by a surface 311. The opening 309 and/or the surface 311 of the collar 308 may have a size and shape that is substantially complementary to the shape of at least a portion of the neck portion 110 of the animal 104. As a result, it is therefore to be understood that the collar 308 may be form fitting to the animal 104 using the animal door assembly 100. This aids in preventing the collar 308 from rotating and/or moving around and/or along the neck portion 110 of the animal 104. By providing a collar 308 that does not rotate and/or move around and/or along the neck portion 110 of the animal 104, it aids in ensuring that the collar attachment portion 184 of the collar 308 remains within the approximately in the same location at all times while on the neck portion 110 of the animal 104. This aids in providing an animal door assembly 100 that is capable of consistently and reliably attaching at least a portion of the collar attachment portion 184 of the collar 308 to at least a portion of the leash attachment portion 188 of the one or more leashes 144.

In accordance with the embodiment illustrated in FIG. 8 and as a non-limiting example, the collar 308 may include one or more padding members 300 extending inward from the surface 311 defining the opening 309 within the collar 308. At least a portion of the one or more padding members 300 may be integrally connected to, or integrally formed as part of, at least a portion of the surface 311 and/or the body portion 182 of the collar 308. The one or more padding members 300 may provide the body portion 182 of the collar 308 with one or more areas in increased thickness. Additionally, the one or more padding members 300 may aid in preventing the collar 308 from rotating and/or moving along the neck portion 110 of the animal 104 thereby ensuring that the collar 308 and/or the collar attachment portion 184 of the collar 308 remains in the same location at all times. This aids in ensuring that the collar attachment portion 184 of the collar 308 is consistently and reliably able to be connected to at least a portion of the leash attachment portion 186 of the one or more leashes 144.

According to the embodiment illustrated in FIG. 8 and as a non-limiting example, the one or more padding members 300 may be in direct contact with at least a portion of a top portion (not shown), the right side portion (not shown), the left side portion (not shown), and/or the bottom portion (not shown) of the neck portion 110 of the animal 104. As best seen in FIG. 8 and as a non-limiting example, the one or more padding portions 300 in contact with the bottom portion (not shown) of the neck portion 110 of the animal 104 may define a receiving portion 304. The receiving portion 304 may be of a size and shape to received and/or retain at least a portion of the throat, trachea, larynx, and/or voice box of the animal 104. This aids in providing a collar 308 that has a customized fit to the animal 104 wearing the collar 308. Additionally, this further aids in preventing the collar 308 from rotating and/or moving along the neck portion 110 of the animal 104. Furthermore, this aids in ensuring that the collar 308 does not restrict the breathing of the animal 104 and/or does not cause damage to the larynx (not shown) of the animal 104. It is within the scope of this disclosure and as a non-limiting example that at least a portion of the receiving portion 304 may have a shape that is substantially complementary to at least a portion of the throat, trachea, larynx, and/or voice box of the animal 104. As a result, the collar 308 is able to be more safely worn by the animal 104.

As illustrated in FIG. 8 and as a non-limiting example, the collar 308 may include one or more collar speakers 302 that are in wired or wireless communication with the one or more control units 162 of the animal door assembly 100. At least a portion of the one or more collar speakers 302 may be in electrical communication with at least a portion of the one or more collar power sources 224 and/or the one or more control units 162 of the animal door assembly 100. The one or more control units 162 may be operably configured to instruct the one or more collar speakers 302 to audibly issue one or more commands and/or messages to the animal 104. The one or more commands and/or messages issued through the one or more collar speakers 302 may be words of encouragement, return commands, and/or any other type of message that aids in the successful operation of the animal door assembly 100 programmed into the one or more control units 162 and/or the one or more computing devices 234. It is within the scope of this disclosure and as a non-limiting example that the one or more collar speakers 302 may be in wireless communication with the one or more control units 162 by utilizing a cellular connection, a wireless connection, an internet connection, and/or any other type of wired or wireless method for transmitting information from one device to another.

In light of the foregoing, the collar 308 and the animal door assembly 100 provides more security for the user (not shown) and aids in preventing unwanted thieves, animals, vermin, bugs, pests, and/or insects from entering into an user's home, garage, shed, and/or outbuilding 106. Additionally, in light of the foregoing, the collar 308 and the animal door assembly 100 prevents the animal 104 from running away once the animal 104 has exited the user's home, garage, shed, and/or outbuilding 106.

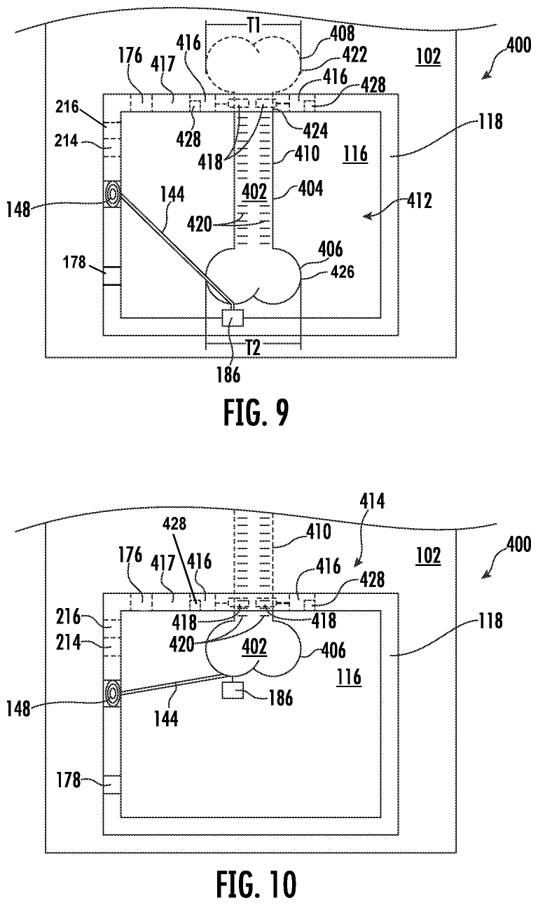

FIGS. 9 and 10 provide a schematic illustration of an animal door assembly 400 according to an alternative embodiment of the disclosure. The animal door assembly 400 illustrated in FIGS. 9 and 10 is the same as the animal door assembly 100 illustrated in FIGS. 1-8, except where specifically noted below. As illustrated in FIGS. 9 and 10 of the disclosure and as a non-limiting example, the animal door assembly 400 may include one or more stop members 402. The one or more stop members 402 may provide the animal 104 with an instructional cue that it is time to go outside the user's home, garage, shed, or outbuilding 106, may provide an indication that it is not time for the animal 104 to go outside the user's home, garage, shed, or outbuilding 106, may provide a way to lock and unlock the animal door 116 of the animal door assembly 400, and/or may provide an additional barrier preventing unwanted thieves, animals, vermin, bugs, pests, and/or insects from entering the user's home, garage, shed, and/or outbuilding 106. It is within the scope of this disclosure and as a non-limiting example that at least a portion of the one or more stopper members 402 may be disposed proximate to, in front of, and/or within the interior of the user's home, garage, shed, and/or outbuilding 106.

As illustrated in FIGS. 9 and 10 of the disclosure and as a non-limiting example, the one or more stopper members 402 may have a body portion 404 having a first end portion 406, a second end portion 408, and an intermediate portion 410 interposed between the first and second end portions 406 and 408. The one or more stopper members 402 may be selectively transitionable between a first position 412 illustrated in FIG. 9 and a second position 414 illustrated in FIG. 10. As the one or more stopper members 402 are transitioned from the first position 412 to the second position 414, the body portion 404 of the one or more stopper members 402 may be received and/or retained within at least a portion of the animal door frame 118 of the animal door assembly 400 and/or within at least a portion of the hollow interior portion (not shown) of the door 102. It is within the scope of this disclosure and as a non-limiting example, that the first position 412 may be a locked position preventing the animal 104 from leaving the user's home, garage, shed, and/or outbuilding 106 and the second position 414 may be an unlocked position allowing the animal 104 to leave the user's home, garage, shed, and/or outbuilding 106 and use the animal door assembly 400.

The animal door assembly 400 may include one or more stopper member motors 416 disposed proximate to at least a portion of the body portion 404 of the one or more stopper members 402. At least a portion of the one or more stopper member motors 416 may be received and/or retained within at least a portion of the animal door frame 118 and/or the hollow interior portion (not shown) of the door 102. Additionally, at least a portion of the one or more stopper member motors 416 may be drivingly connected to at least a portion of the body portion 404 of the one or more stopper members 402 in order to selectively transition the one or more stopper members 402 between the first and second positions 414 and 414. It is within the scope of this disclosure and as a non-limiting example that the one or more stopper member motors 416 may be one or more motors, one or more electric motors, one or more actuators, one or more linear actuators, and/or any other type of device that is capable of transitioning the one or more stopper members 402 between the first and second positions 412 and 414.

The one or more stopper member motors 416 may be in electrical communication with at least a portion of one or more animal door power sources 417. Additionally, the one or more stopper member motors 416 may be in wired or wireless communication with the one or more control units 162. At least a portion of the one or more animal door power sources 417 may be received and/or retained within at least a portion of the animal door 116, the animal door frame 118 and/or the door 102. It is within the scope of this disclosure and as a non-limiting example that the one or more animal door power sources 417 one or more batteries, one or more electro-chemical cells, one or more secondary cells, one or more rechargeable batteries, and/or any other type of device capable of supplying an amount of electrical power. Additionally, it is within the scope of this disclosure and as a non-limiting example that the that the wireless connection between the one or more stopper member motors 416 and the one or more control units 162 may be a cellular connection, a wireless connection, an internet connection, and/or any other type of wired or wireless method for transmitting information from one device to another.

In accordance with the embodiment where the one or more stopper member motors 416 are one or more electric motors, the one or more stopper member motor 416 may be drivingly connected to a gear or a gear assembly 418 that is drivingly connected to at least a portion of the body portion 404 of the one or more stopper members 402. The gear or gear assembly 418 may have a plurality of teeth (not shown) that are complementary to and meshingly engaged with at least a portion of a plurality of teeth 420 on at least a portion of the body portion 404 of the one or more stopper members 402. It is within the scope of this disclosure and as a non-limiting example that the plurality of teeth 420 on the body portion 404 of the one or more stopper members 402 may be connected to or integrally formed as part of at least a portion of the body portion 404 of the one or more stopper members 402.

At least a portion of the second end portion 408 of the one or more stopper members 402 may include an increased diameter portion 422. The increased diameter portion 422 on the second end portion 408 of the one or more stopper members 402 may have a thickness T1. The thickness T1 of the increased diameter portion 422 on the second end portion 408 of the one or more stopper members 402 may be such the increased diameter portion 422 aids in ensuring that the one or more stopper members 402 do not fall through an opening 424 within the animal door frame 118 when a failure within the animal door assembly 400 occurs. This aids in ensuring that the one or more stopper members 402 provides the desired locking function even if the animal door assembly 400 experiences a failure.

At least a portion of the first end portion 406 of the one or more stopper members 402 may include an increased diameter portion 426. The increased diameter portion 426 on the first end portion 406 of the one or more stopper members 402 may have a thickness T2. The thickness T2 may be greater than the opening 424 within the animal door frame 118 for the one or more stopper members 402. This aids in ensuring that the one or more stopper members 402 do not transition beyond a pre-determined point within the hollow interior portion (not shown) of the door 102. As a result, even if a failure within the one or more stopper member motor 416 and/or the one or more control units 162, the one or more stopper member motor 416 will not drive the one or more stopper members 402 beyond a pre-determined point. It is within the scope of this disclosure and as a non-limiting example, that at least a portion of the increased diameter portion 426 on the first end portion 406 of the one or more stopper members 402 may be in direct contact with at least a portion of the animal door frame 118 and/or the door 102 when the one or more stopper members 402 are in the second position 414 illustrated in FIG. 10.

According to an embodiment of the disclosure and as a non-limiting example, the increased diameter portion 426 on the first end portion 406 of the one or more stopper members 402 may be adjustable by the user (not shown). This may allow the user (not shown) to set the height in which the leash attachment portion 186 will hang above the ground 153. The one or more stopper member motors 416 may include one or more sensors 428 that are operably configured to sense an amount of resistance experienced by the increased diameter portion 426 contacting at least a portion of the animal door frame 118 and/or the door 102. Once the resistance is sensed, power to the one or more stopper member motors 416 may be ceased preventing further movement of the one or more stopper members 402.

In accordance with an embodiment of the disclosure and as a non-limiting example, at least a portion of the first end portion 146 of the one or more leashes 144 and/or the leash attachment portion 186 may be connected to at least a portion of the first end portion 406 of the one or more stopper members 402. This aids in ensuring that the leash attachment portion 186 is placed in the same position each time the animal 104 is going to use the animal door assembly 400 and needs to have the leash attachment portion 186 attach to at least a portion of the collar attachment portion 184. As a result, this aids in providing an animal door assembly 400 that is able to consistently and reliably attach at least a portion of the leash attachment portion 186 to at least a portion of the collar attachment portion 184. It is within the scope of this disclosure and as a non-limiting example that the first end portion 146 and/or the leash attachment portion 186 of the one or more leashes 144 may be connected to at least a portion of the first end portion 406 of the one or more stopper members 402 by a magnetic connection or a loop connection that the one or more leashes 144 are allowed to move through freely.

In light of the foregoing, the animal door assembly 100 provides more security for the user (not shown) and aids in preventing unwanted thieves, animals, vermin, bugs, pests, and/or insects from entering into a user's home, garage, shed, and/or outbuilding 106. Additionally, in light of the foregoing, the animal door assembly 100 prevents the animal 104 from running away once the animal 104 has exited the user's home, garage, shed, and/or outbuilding 106.

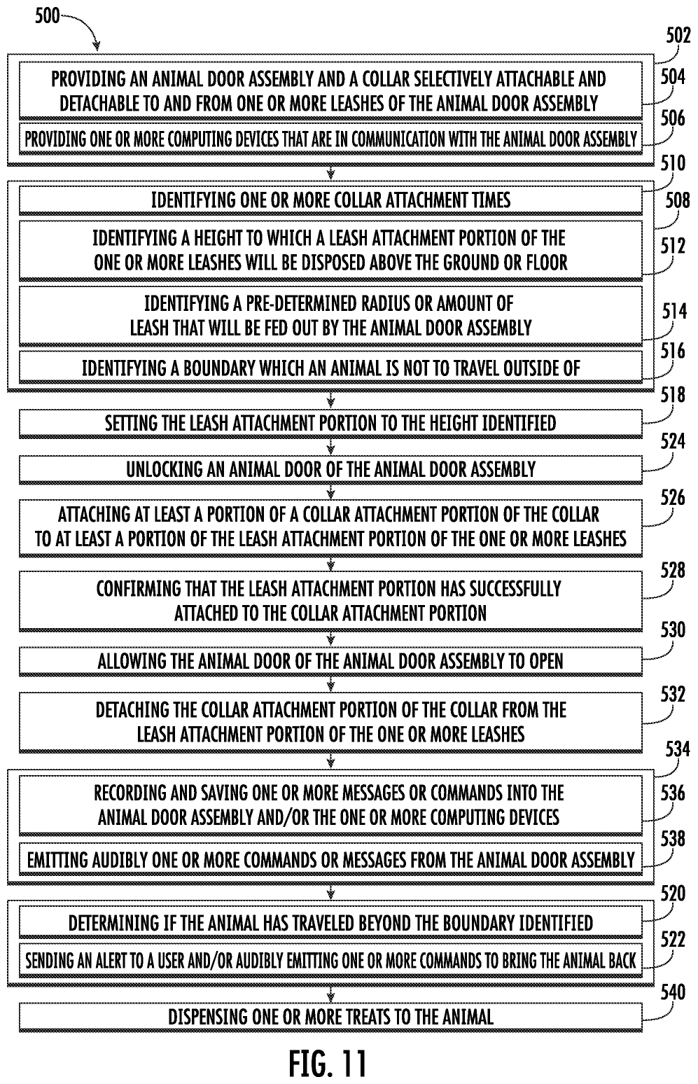

FIG. 11 provides a flow chart illustrating a method 500 of operating the animal door assembly 100 and/or 400 described and illustrated in relation to FIGS. 1-10 of the disclosure. The method of operating 500 includes a providing step 502. As illustrated in FIG. 11 of the disclosure and as a non-limiting example, the providing step 502 includes the step of providing 504 an animal door assembly 100 and/or 400 and a collar 108 and/or 308 that is selectively attachable and detachable to and/or from at least a portion of a leash attachment portion 186 of the one or more leashes 144. Additionally, the providing step 502 may include the step of providing 506 one or more computing devices 234 that are in communication with at least a portion of the animal door assembly 100 and/or 400.

In accordance with an embodiment of the disclosure and as a non-limiting example, the method of operation 500 may include an identifying, setting, and/or programming step 508. The identifying, setting, and/or programming step 508 may include the step of identifying one or more collar attachment times 510. The one or more collar attachment times may be a specified time that the user (not shown) has set as the time(s) in which the animal 104 is to use the animal door assembly 100 and/or 400 to go outside the user's home, garage, shed, or outbuilding 106. These times 510 may be inputted or programmed into the downloadable program or application installed within the one or more computing devices 234 and/or may be inputted or programmed into the one or more control units 162 of the animal door assembly 100 and/or 400. Once the one or more control units 162 of the animal door assembly 100 and/or 400 have identified or determined that the time element has been met, the one or more control units 162 may begin the procedure(s) needed to attach at least a portion of the one or more leash attachment portions 186 of the one or more leashes 144 to at least a portion of the collar attachment portion 184 of the collar 108 and/or 308.

According to the embodiment illustrated in FIG. 11 and as a non-limiting example, the identifying, setting, and/or programming step 508 may include the step of identifying a height 512 to which the leash attachment portion 186 will be disposed above the ground or floor 153. The height 512 may be inputted or programmed into the downloadable program or application installed within the one or more computing devices 234 and/or may be inputted or programmed into the one or more control units 162 of the animal door assembly 100 and/or 400. By identifying the height 512, it aids in ensuring that the animal door assembly 100 and/or 400 consistently and reliably attach at least a portion of the leash attachment portion 186 to at least a portion of the collar attachment portion 184. Once the one or more control units 162 have determined that the animal 104 is going to user the animal door assembly 100 and/or 400, the animal door assembly 100 and/or 400 may set the least attachment portion 186 to the height 512.

The identifying, setting, and/or programming step 508 may include the step of identifying a pre-determined radius or length of leash that will be fed out 514 by the animal door assembly 100 and/or 400. Because the one or more leashes 144 provide a physical tether between the animal 104, the door 102, and/or the animal door assembly 100 and/or 400, by identifying the pre-determined radius or length of leash that will be fed out 514, the overall amount of distance that the animal 104 may be able to more away from the animal door assembly 100 and/or 400 may be set. The pre-determined radius or length of leash that will be fed out 514 by the animal door assembly 100 and/or 400 may be inputted or programmed into the downloadable program or application installed within the one or more computing devices 234 and/or may be inputted or programmed into the one or more control units 162 of the animal door assembly 100 and/or 400.

As illustrated in FIG. 11 of the disclosure and as a non-limiting example, the identifying, setting, and/or programming step 508 may include the step of identifying a boundary 516 in which the animal 104 is not allowed to travel beyond. The boundary 516 may be inputted or programmed into the downloadable program or application installed within the one or more computing devices 234 and/or may be inputted or programmed into the one or more control units 162 of the animal door assembly 100 and/or 400. Once the animal door assembly 100 and/or 400 has identified or determined 520 that the animal 104 has traveled beyond the boundary 516, the animal door assembly 100 and/or 400 may send an alert or message 522 to the user (not shown) on the one or more computing devices 234 indicating that the animal 104 has escaped or run away. Additionally, one the animal door assembly 100 and/or 400 has identified or determined 520 that the animal 104 has traveled beyond the boundary 516, the one or more control units 162 of the animal door assembly 100 and/or 400 may instruct the one or more speakers 176 to audibly emit a message or command instructing the animal 104 to return. This message or command may be selected by the user (not shown) or may be recorded by the user (not shown) within the animal door assembly 100 and/or 400.

The method of operation 500 may include the step of setting 518 the least attachment portion 186 to the height identified 512 and/or unlocking 524 the animal door 116 of the animal door assembly 100 and/or 400. This height setting step 518 and the unlocking step 524 may be performed once it has been determined that the animal 104 is going to use the animal door assembly 100 and/or 400. Once the animal door 116 has been unlocked 524, the animal door 116 may be able to open allowing the animal 104 to exit the user's home, garage, shed, or outbuilding 106.

After the one or more leash attachment portions 186 have been set 518 to the pre-determined height identified, one or more attachment steps 526 may occur. During the one or more attachment steps 526, at least a portion of the collar attachment portion 184 of the collar 108 and/or 308 may be attached or connected to at least a portion of the leash attachment portion 186 of the one or more leashes 144. Once the collar attachment portion 184 has been attached to the leash attachment portion 188, the one or more leashes 144 provide a physical tether between the animal 104 and the door 102 and/or the animal door assembly 100 and/or 400.

After the attachment step 526 has occurred, a confirmation step 528 may occur. During the attachment confirmation step 528 may be operably configured in order to confirm that the one or more leash attachment portions 186 of the one or more leashes 144 have been successfully connected or attached to at least a portion of the collar attachment portion 184 of the collar 108 and/or 308. It is within the scope of this disclosure and as a non-limiting example that the attachment confirmation step 528 may be achieved based on the data collected from the one or more sensors 160 within the one or more rotational devices 158, the one or more first mat sensors 212, the one or more second mat sensors 218, the one or more collar sensors 208, the one or more leash sensors 210, the one or more first animal door sensors 214, and/or the one or more second animal door sensors 216 and analyzed by the one or more control units 162 and/or the one or more computing devices 234.

Once the animal 104 has returned or re-entered into the user's home, garage, shed, or outbuilding 106, the animal door assembly 100 and/or 400 may begin one or more steps needed to detach 532 the leash attachment portion 186 of the one or more leashes 144 from the collar attachment portion 184 of the collar 108 and/or 308. After the leash attachment portion 186 has been successfully detached 532 from the collar 108 and/or 308 on the animal 104, the animal 104 may be able to freely move within the user's home, garage, shed, or outbuilding 106.

It is within the scope of this disclosure and as a non-limiting example that the detachment step 532 may include a detachment confirmation step. As a non-limiting example that the detachment confirmation step may be achieved based on the data collected from the one or more sensors 160 within the one or more rotational devices 158, the one or more first mat sensors 212, the one or more second mat sensors 218, the one or more collar sensors 208, the one or more leash sensors 210, the one or more first animal door sensors 214, and/or the one or more second animal door sensors 216 and analyzed by the one or more control units 162 and/or the one or more computing devices 234.

As illustrated in FIG. 11 and as a non-limiting example, the method of operation 500 may include a messaging step 534. The messaging step 534 may include a step of recording, saving, and/or selecting one or more messages or commands 520 to be audibly emitted 538 by the one or more speakers 176 and/or the one or more collar speakers 302. It is within the scope of this disclosure and as a non-limiting example that the one or more messages or commands 520 audibly emitted 538 by the one or more speakers 176 and/or the one or more collar speakers 302 may be issued to bring the animal 104 back into the user's home, garage, shed, or outbuilding 106, to bring the animal 104 back into the user's home, garage, shed, or outbuilding 106 once the animal 104 has traveled beyond the boundary 516 identified, and/or to instruct the animal 104 to use the animal door assembly 100 and/or 400.

The method of operation 500 may include a step of identifying a number 540 of the one or more treats 180 to dispense and dispensing 540 one or more treats 180 from the animal door assembly 100 and/or 400. The one or more treats 180 may be dispensed 540 to instruct the animal 104 to use the animal door assembly 100 and/or 400, to train the animal 104 to use the animal door assembly 100 and/or 400, to reward the animal 104 for successfully using the animal door assembly 100 and/or 400, and/or to encourage the animal 104 to come back to the user's home, garage, shed, or outbuilding 106.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to from the inventive concepts defined in the appended claims.

In accordance with the provisions of the patent statutes, the present invention has been described to represent what is considered to represent the preferred embodiments. However, it should be note that this invention can be practiced in other ways than those specifically illustrated and described without departing from the spirit or scope of this invention.

What is claimed is:

1. An animal door assembly, comprising:
an animal door that is connected to at least a portion of a door;
wherein said animal door is selectively movable between a first position and a second position;
one or more leashes having a leash attachment portion;
a collar having a collar attachment portion; and
wherein at least a portion of said collar attachment portion of said collar is selectively attachable and detachable to and from at least a portion of said leash attachment portion of said one or more leashes.

2. The animal door assembly of claim 1, further comprising one or more locking assemblies;
wherein said one or more locking assemblies are selectively transitionable between a first unlocked position and a second locked position; and
wherein when said one or more locking assemblies are in said first unlocked position said animal door is able to open and when said one or more locking assemblies are in said second locked position said animal door is prevented from being opened.

3. The animal door assembly of claim 2, wherein at least a portion of said one or more locking assemblies are received and/or retained within at least a portion of one or more lock receiving portions within a body portion of said animal door when said one or more locking assemblies are in said second locked position.

4. The animal door assembly of claim 1, further comprising one or more spool assemblies; and
wherein said one or more spool assemblies allow a pre-determined amount of said one or more leashes to be dispensed.

5. The animal door assembly of claim 4, wherein said one or more spool assemblies comprise one or more rotation devices;
wherein said one or more rotational devices are operably configured to allow said pre-determined amount of said one or more leashes to be dispensed; and
wherein said one or more rotational devices are operably configured to retrieve said pre-determined amount of said one or more leashes to be dispensed.

6. The animal door assembly of claim 5, wherein said one or more rotational devices are one or more biasing members and/or one or more electric motors.

7. The animal door assembly of claim 5, wherein said one or more rotational devices comprise one or more sensors that are in communication with one or more control units to determine said amount of said one or more leashes dispensed.

8. The animal door assembly of claim 5, wherein said one or more spool assemblies comprise one or more ratchet assemblies having one or more gear wheels and one or more pawls;
wherein said one or more pawls are selectively engagable with said one or more gear wheels of said one or more ratchet assemblies to prevent rotation of said one or more rotational devices and dispensing of said one or more leashes.

9. The animal door assembly of claim 8, wherein said one or more ratchet assemblies are in communication with one or more control units;
wherein said one or more control units instruct said one or more pawls to engage said one or more gear wheels of said one or more ratchet assemblies when a pre-determined amount of said one or more leashes has been dispensed.

10. The animal door assembly of claim 1, further comprising one or more stopper members;
wherein said one or more stopper members are selectively transitionable between a first position and a second position; and
when said one or more stopper members are in a first position said animal door is unable to be opened and when said one or more stopper members are in a second position said animal door is able to be opened.

11. The animal door assembly of claim 10, wherein at least a portion of a first end portion of said one or more leashes or at least a portion of said leash attachment portion of said one or more leashes are connected to at least a portion of a first end portion of said one or more stopper members.

12. The animal door assembly of claim 1, wherein said collar has a body portion with an opening therein defined by a surface;
wherein at least a portion of one or more padding members are integrally connected to or integrally formed as part of said surface defining said opening within said collar; and
wherein said one or more padding members keep said collar attachment portion of said collar in a substantially constant location.

13. The animal door assembly of claim 1, wherein said collar attachment portion comprises an attachment rod and wherein said leash attachment portion comprises a hook member and a locking member;
wherein said locking member of said leash attachment portion is movable between a first and second position;
wherein when said locking member of said leash attachment portion is in said first position said attachment rod of said leash attachment portion is able to enter into an opening defined by said locking member and said hook member of said leash attachment portion; and
wherein when said locking member of said leash attachment portion is in said second position said attachment rod of said leash attachment portion is locked within said opening defined by said locking member and said hook member of said leash attachment portion.

14. The animal door assembly of claim 13, wherein at least a portion of said hook member of said leash attachment portion is magnetically attached to at least a portion of said attachment rod of said collar attachment portion; and
wherein said magnetic attraction between said hook member of said leash attachment portion and said attachment rod of said collar attachment portion drives said attachment rod of said collar attachment portion into an attachment position.

15. Animal door assembly of claim 1, wherein said leash attachment portion comprises one or more leash sensors and wherein said collar attachment portion comprises one or more collar sensors;
wherein said one or more leash sensors and said one or more collar sensors are in communication with one or more control units to determine a location of said leash attachment portion relative to said collar attachment portion; and
wherein when said one or more control units determine that said leash attachment portion and said collar attachment potion are in an attachment position said one or more control units instruct said leash attachment portion and said collar attachment portion to lock relative to each other attaching said one or more leashes to said collar.

16. A method of operating an animal door assembly, the method comprising:
providing an animal door, a collar having a collar attachment portion, and one or more leashes having a leash attachment portion;
identifying a height which said leash attachment portion will be located above a floor;
identifying a pre-determined radius or amount of said one or more leashes that will be dispensed by said animal door assembly;
attaching at least a portion of said leash attachment portion to at least a portion of said collar attachment portion;
allowing an amount of said one or more leashes to dispense an amount substantially equal to said pre-determined radius identified;
stopping said one or more leashes from dispensing after an amount of said one or more leashes that have bene dispensed is substantially equal to said pre-determined radius identified; and
detaching said collar attachment portion of said collar from said leash attachment portion of said one or more leashes.

17. The method of claim 16, further comprising the step of:
confirming that said leash attachment portion of said one or more leashes has been successfully attached to said collar attachment portion of said collar; and/or confirming that said leash attachment portion of said one or more leashes has been successfully detached from said collar attachment portion of said collar.

18. The method of claim 16, further comprising the steps of:
identifying a boundary for an animal wearing said collar;
determining whether said collar has traveled beyond said boundary identified; and
sending an alert and/or issuing an audible command retrieving said animal.

19. The method of claim 16, further comprising the steps of:
identifying a time for when the leash attachment portion of said one or more leashes is to be attached to said collar attachment portion of said collar;
setting said leash attachment portion to said leash attachment height identified before at least a portion of said leash attachment portion is attached to at least a portion of said collar attachment portion.

20. The method of claim 16, further comprising the step of:
dispensing one or more treats.
